(19) United States
(12) Patent Application Publication
(10) Pub. No.: US 2011/0278475 A1
(43) Pub. Date: Nov. 17, 2011

(54) MULTIPLEX ILLUMINATION SYSTEM AND METHOD

(75) Inventors: Paul Lundquist, San Francisco, CA (US); Cheng Frank Zhong, Fremont, CA (US); Pegian Zhao, Mountain View, CA (US); Stephen Tumer, Menlo Park, CA (US)

(73) Assignee: Pacific Biosciences of California, Inc, Menlo Park, CA (US)

(21) Appl. No.: 13/191,279

(22) Filed: Jul. 26, 2011

Related U.S. Application Data
(63) Continuation of application No. 11/901,273, filed on Sep. 14, 2007, now abandoned.
(60) Provisional application No. 60/928,617, filed on May 10, 2007.

(51) Int. Cl. G01J 1/58

(52) U.S. Cl. 250/459.1; 250/458.1

(57) ABSTRACT

Systems and methods for analyzing highly multiplexed sample arrays using highly multiplexed, high density optical systems to illuminate high density sample arrays and/or provide detection from such high density arrays. Systems and methods comprise substrates having an array of discrete signal sources having a pitch P2, and an optical system that divided illumination light into an array of illumination spots, the illumination spots having a pitch P1 that is less than P2.

### CROSS-REFERENCE TO RELATED APPLICATIONS

The present application is a continuation of U.S. patent application Ser. No. 11/901,273, filed Sep. 14, 2007, which claims priority from Provisional U.S. Patent Application No. 60/928,617, filed May 10, 2007, the full disclosures of which are hereby incorporated by reference in their entirety for all purposes.

### STATEMENT REGARDING FEDERALLY SPONSORED RESEARCH

Not Applicable.

### BACKGROUND OF THE INVENTION

Optical detection systems are generally employed in a wide variety of different analytical operations. For example, simple multi-well plate readers have been ubiquitously employed in analyzing optical signals from fluid based reactions that were being carried out in the various wells of a multiwell plate. These readers generally monitor the fluorescence, luminescence or chromogenic response of the reaction solution that results from a given reaction in each of 96, 384 or 1536 different wells of the multiwell plate.

Other optical detection systems have been developed and widely used in the analysis of analytes in other configurations, such as in flowing systems, i.e., in the capillary electrophoretic separation of molecular species. Typically, these systems have included a fluorescence detection system that directs an excitation light source, e.g., a laser or laser diode, at the capillary, and is capable of detecting when a fluorescent or fluorescently labeled analyte flows past the detection region (see, e.g., ABI 3700 Sequencing systems, Agilent 2100 Bioanalyzer and ALP systems, etc.)

Still other detection systems direct a scanning laser at surface bound analytes to determine where, on the surface, the analytes have bound. Such systems are widely used in molecular array based systems, where the positional binding of a given fluorescently labeled molecule on an array indicates a characteristic of that molecule, e.g., complementarity or binding affinity to a given molecule (See, e.g., U.S. Pat. No. 5,578,832).

Notwithstanding the availability of a variety of different types of optical detection systems, the development of real-time, highly multiplexed, single molecule analyses has given rise to a need for detection systems that are capable of detecting large numbers of different events, at relatively high speed, and that are capable of deconvolving potentially complex, multi-wavelength signals. Further, such systems generally require enhanced sensitivity and as a result, increased signal-to-noise ratios with lower power requirements. The present invention meets these and a variety of other needs.

### BRIEF SUMMARY OF THE INVENTION

The present invention is generally directed to highly multiplexed optical interrogation systems, and particularly to highly multiplexed fluorescence based detection systems.

In a first aspect, the invention includes multiplex fluorescence detection systems that comprise an excitation illumination source, and an optical train that comprises an illumination path and a fluorescence path. In the context of certain aspects of the invention, the illumination path comprises an optical train that comprises multiplex optics that convert a single originating illumination beam from the excitation illumination source into at least 10 discrete illumination beams, and an objective lens that focuses the at least 10 discrete illumination beams onto at least 10 discrete locations on a substrate. The fluorescence path comprises collection and transmission optics that receive fluorescent signals from the at least 10 discrete locations, and separately direct the fluorescent signals from each of the at least 10 discrete locations through a confocal filter and focus the fluorescent signals onto a different location on a detector.

In a related aspect, the invention provides a system for detecting fluorescence from a plurality of discrete locations on a substrate, which system comprises a substrate, an excitation illumination source a detector, and an optical train positioned to receive an originating illumination beam from the excitation illumination source. In the context of certain aspects of the invention, the optical train is configured to convert the originating illumination beam into a plurality of discrete illumination beams, and focus the plurality of discrete illumination beams onto a plurality of discrete locations on the substrate, wherein the plurality of discrete locations are at a density of greater than 1000 discrete illumination spots per mm², preferably greater than 10,000 discrete spots per mm², more preferably greater than 100,000 discrete illumination spots per mm², in many eases greater than 250,000 discrete illumination spots per mm², and in some cases up to and greater than 1 spot per μm². In terms of inter-spot spacing upon the substrate, the illumination patterns of the invention will typically provide spacing between adjacent spots (in the closest dimension), of less than 100 μm, center to center, preferably, less than 20 μm, more preferably, less than 10 μm, and in many preferred cases, spacing between spots of 1 μm or less, center to center. As will be appreciated, such spacing generally refers to inter-spot spacing in the closes dimension, and does not necessarily reflect inter-row spacing that may be substantially greater, due to the allowed spacing for spectral separation of adjacent rows, as discussed elsewhere herein. The optical train is further configured to receive a plurality of discrete fluorescent signals from the plurality of discrete locations, and focus the plurality of discrete fluorescent signals through a confocal filter, onto the detector.

In other aspects, the invention provides systems for collecting fluorescent signals from a plurality of locations on a substrate, which comprise excitation illumination optics configured to simultaneously provide excitation radiation to an area of a substrate that includes the plurality of locations, and fluorescence collection and transmission optics that receive fluorescent signals from the plurality of locations on the substrate, and separately direct the fluorescent signals from each of the plurality of locations through a separate confocal aperture in a confocal filter and image the fluorescent signals onto a detector.

Relatedly, the invention also provides systems for detecting fluorescent signals from a plurality of discrete locations on a substrate, that comprise an excitation illumination source, a diffractive optical element or holographic phase mask, positioned to convert a single originating illumination beam from the excitation illumination source into at least 10 discrete beams each propagating at a unique angle relative to the originating beam, an objective for focusing the at least ten discrete beams onto at least 10 discrete locations on a substrate, fluorescence collection and transmission optics, and a detector. In the context of certain aspects of the invention, the fluorescence collection and transmission optics are positioned to receive fluorescent signals from the plurality of discrete locations and transmit the fluorescent signals to the detector.

In other aspects, the invention provides methods of detecting a plurality of discrete fluorescent signals from a plurality of discrete locations on a substrate. The methods comprise simultaneously and separately illuminating each of the plurality of discrete locations on the substrate with excitation illumination. Fluorescent signals from each of the plurality of locations are simultaneously and separately collected and each of the fluorescent signals from the plurality of discrete locations is separately directed through a confocal filter, and separately imaged onto a discrete location on a detector.

In addition to the foregoing, the invention is also directed to the use of any of the foregoing systems and/or methods in a variety of analytical operations.

### BRIEF DESCRIPTION OF THE DRAWINGS

FIG. 1 provides a schematic illustration of the systems of the invention.

FIG. 2 schematically illustrates a targeted illumination pattern generated from an originating beam passed through differently oriented diffraction gratings.

FIG. 3 shows an SEM image of a microlens array and the simulated corresponding targeted illumination pattern generated from illumination through the lens array.

FIG. 4 shows an image of a diffractive optical element (DOE) phase mask and its corresponding illumination pattern.

FIG. 5 shows an illumination pattern from a DOE designed to yield very high illumination multiplex.

FIG. 6 schematically illustrates a targeted illumination pattern generated from overlaying illumination patterns from two DOEs but offsetting them by a half period.

FIG. 7 schematically illustrates an illumination path including a polarizing beam splitting element.

FIG. 8 schematically illustrates a portion of a confocal mask in accordance with the present invention.

FIG. 9 schematically illustrates the illumination and fluorescence paths of one exemplary system according to the invention.

### DETAILED DESCRIPTION OF THE INVENTION

The present invention is directed at systems and methods for high resolution, highly multiplexed analysis of optical signals from large numbers of discrete signal sources, and particularly signal sources that are of very small dimensions and which are arrayed on or within substrates at regularly spaced intervals.

### I. General

Increasing throughput of chemical, biochemical and/or biological analyses has generally relied, at least in part, on the ability to multiplex the analysis. Such multiplex generally utilizes the simultaneous analysis of multiple different samples that are either physically discrete or otherwise separately identifiable within the analyzed material. Examples of such multiplex analysis include, e.g., the use of multi-well plates and corresponding plate readers, to optically interrogate multiple different reactions simultaneously. Such plate systems have been configured to include 16 wells, 32 wells, 96 wells, 384 wells and even 1536 wells in a single plate that can be interrogated simultaneously.

Other multiplex systems include array based technologies in which solid substrates bearing discrete patches of different molecules are reacted with a certain set of reagents and analyzed for reactivity, e.g., an ability to hybridize with a given target nucleic acid molecule. Such arrays are simultaneously interrogated with the reagents and then analyzed to identify the reactivity of such reagents with the different reagents immobilized upon different regions of the substrate.

Another multiplex system utilizes arrays of optical confinements in which reactions may be carried out, and in which a very small volume of reaction mixture will be subject to optical interrogation. Such systems include, for example, zero mode waveguide arrays, where each waveguide is illuminated such that only a very small volume of material within the waveguide is actually illuminated, due to the evanescent decay of the illumination within the optically confined core of the waveguide. See, e.g., U.S. Pat. Nos. 6,917,726, 7,013,054, 7,181,122, and Levene et al., Science 2003:299:682-686, the full disclosures of which are incorporated herein by reference in their entirety for all purposes. Such systems are particularly useful in the optical analysis of chemical and biochemical reactions, particularly at the single molecule level. Of particular interest is the observation of template dependent, polymerase mediated primer extension reactions which can be monitored to identify the rate or identity of nucleotide incorporation, and thus, sequence information. See, e.g., U.S. Pat. Nos. 7,033,764, 7,052,847, 7,056,661, 7,056,676, the full disclosures of which are incorporated herein by reference in their entirety for all purposes.

While the ability to multiplex is theoretically only limited by the amount of area in which you can place your multiple samples and then analyze them, realistic analytical systems face constraints of laboratory space and cost, As such, the amount of multiplex that can be derived in the analysis of discrete signal sources or sample regions using a realistic instrumentation system is somewhat limited by the ability to obtain useful signal information from increasing small amounts of materials or small areas of substrates, plates or other analysis regions. In particular, as such signal sources are reduced in size, area or number of molecules to be analyzed, the amount of detectable signal likewise decreases, as does the signal to noise ratio of the system. At the same time, the tolerances of the optical systems must be tightened, and in many cases, and a host of other considerations must be addressed, such as signal processing, heat dissipation, and the like. In addition to these issues, a loss of system flexibility typically accompanies the loss in signal quality.

The present invention provides methods and systems for high resolution, highly flexible, highly multiplexed analysis of signal sources, and particularly signal sources that are associated with analysis of chemical, biochemical and/or biological materials. In particular, the systems and methods of the invention are useful in the targeted illumination and detection of optical signals, e.g., fluorescence, from a large number of discrete signal sources or signal source regions on a substrate with a high signal to noise ratio, lower power requirements, greater flexibility and a host of other improvements.

In the context of the present invention, the optical signal sources that are analyzed using the methods and systems typically may comprise any of a variety of materials, and particularly those in which optical analysis may provide useful information. Of particular relevance to the present invention are optical signal sources that comprise chemical, biochemical or biological materials that can be optically analyzed to identify one or more chemical, biochemical and/or biological properties. Such materials include chemical or biochemical reaction mixtures that may be analyzed to determine reactivity under varying conditions, varying reagent concentrations, exposure to different reagents, or the like. Examples of materials of particular interest include proteins such as enzymes, their substrates, antibodies and/or antigens, biochemical pathway components, such as receptors and ligands, nucleic acids, including complementary nucleic acid associations, nucleic acid processing systems, e.g., ligases, nucleases, polymerases, and the like. These materials may also include higher order biological materials, such as prokaryotic or eukaryotic cells, mammalian tissue samples, viral materials, or the like.

Optical interrogation or analysis of these materials may generally involve known optical analysis concepts, such as analysis of light absorbance, transmittance and/or reflectance of the materials being analyzed. In other aspects, such analysis may determine a level of optical energy emanating from the system. In some cases, material systems may produce optical energy, or light, as a natural product of the process being monitored, as is the case in systems that use chemiluminescent reporter systems, such as pyrosequencing processes (See, e.g., U.S. Pat. No. 6,210,891). In particularly preferred aspects, however, optical analysis of materials in accordance with the present invention comprises analysis of the materials' fluorescent characteristics, e.g., the level of fluorescent emissions emanating from the material in response to illumination with an appropriate excitation radiation. Such fluorescent characteristics may be inherent in the material being analyzed, or they may be engineered or exogenously introduced into the system being analyzed. By way of example, the use of fluorescently labeled reagent analogs in a given system can be useful in providing a fluorescent signal event associated with the reaction or process being monitored.

In certain aspects, the optical signal sources analyzed in the invention are referred to as being provided on a substrate. In accordance with the invention, such substrates may comprise any of a wide variety of supporting substrates upon which such signal sources may be deposited or otherwise provided, depending upon the nature of the material and the analysis to be performed. For example, in the case of fluid reagents, such substrates may comprise a plate or substrate bearing one or more reaction wells, where each signal source may comprise a discrete reaction well on the plate, or even a discrete region within a given reaction well. In terms of multi-well plates, as noted above, such plates may comprise a number of discrete and fluidically isolated reaction wells. In fact, such plates are generally commercially available in a variety of formats ranging from 8 wells, to 96 wells, to 384 wells to 1536 wells, and greater. In certain aspects, each discrete well on a multi-well plate may be considered a discrete signal source. However, in some aspects, a single well may include a number of discrete signal sources. As used herein, a discrete signal source typically denotes a signal source that is optically resolvable and separately identifiable from another adjacent signal source. Such separate identification may be a result of different chemical or biochemical characteristics of such signal source or merely result from spatial differentiation between such signal sources.

One example of a particularly useful substrate in the context of the invention, and which may be used herein as an exemplary embodiment for purposes of discussion, is a zero mode waveguide (ZMW) array. Such ZMW arrays, their structure and use, is described in greater detail below, and in U.S. Pat. Nos. 6,917,726, 7,013,054, 7,181,122, which were each previously incorporated herein by reference in their entirety for all purposes. In brief, these arrays typically comprise a transparent substrate having an opaque, e.g., typically a metal, layer disposed over its surface. A number of apertures are provided in the metal layer through to the transparent substrate. In waveguide nomenclature, the apertures are typically referred to as cores, while the metal layer functions as the cladding layer. Provision of cores with nanometer dimension cross-sections and illumination from one end of the cores, results in very small illumination volumes within each core, which may be exploited for a number of different analyses, e.g., single molecule analyses.

In order to maximize throughput of analyses, large numbers of discrete waveguides are typically provided on a given substrate to be analyzed or interrogated simultaneously, providing a need for highly multiplexed illumination and collection/detection systems. Further, because of the dimensions and density of features, e.g., waveguide cores, on such substrates, the illumination and detection systems are subject to a number of different challenges, of which the nature and solutions are addressed in greater detail below.

Other substrates that find application in the context of the invention, particularly in the field of biochemical analysis, include planar substrates upon which are provided arrays of varied molecules, e.g., proteins or nucleic acids. In such cases, different features on the array, e.g., spots or patches of a given molecule type, may comprise a discrete signal source.

The methods and systems of the invention are generally applicable to a wide variety of multiplexed analysis of a number of discrete optical signal sources on a substrate. Of particular benefit in the present invention is the applicability of such systems and inventions to extremely high density arrays of such optical signal sources and/or arrays of such signal sources where each signal source is of extremely small area and/or signal generating capability. Examples of such arrayed signal sources include, for example, high density arrays of molecules, e.g., nucleic acids, high density multi-well reaction plates, arrays of optical confinements, and the like. A variety of other applications are also enhanced through the systems described herein, and these are described in greater detail below.

### II. System

A. General Description

As noted previously, the methods and systems of the present invention provide highly multiplexed illumination and/or detection of optical signals from arrays of discrete optical signal sources and/or illumination targets, with extremely high sensitivity, detecting signal levels at even the single molecule level. The systems of the invention have the further advantage of providing high sensitivity detection at relatively high signal to noise ratios, by reducing external reaction noise stemming from, e.g., fluorescence of out of focus portions of the reaction system or its supporting substrates, reducing required illumination power, and the like. The systems of the invention typically operate by providing targeted illumination patterns onto the desired substrate. As used herein, targeted illumination broadly refers to the direction of illumination to desired locations, but not other locations, e.g., on a substrate. In the context of the multiplex systems described herein, such targeted illumination also typically refers to the direction of illumination to multiple discrete regions on the substrate, which regions preferably do not overlap to any substantial level. As will be appreciated, such targeted illumination preferably directs a large number of discrete illumination beams to a large number of substantially discrete locations on a substrate, in order to separately interrogate such discrete regions. As will also be appreciated the systems of the invention do not necessarily require a complete absence of overlap between adjacent illumination regions, and substantial lack of overlap, e.g., less than 20%, preferably less than 10% overlap and more preferably less than 5% of the illumination in one spot will overlap with an adjacent spot (when plotted as spot illumination intensity, e.g., from an imaging detector such as a CCD or EMCCD).

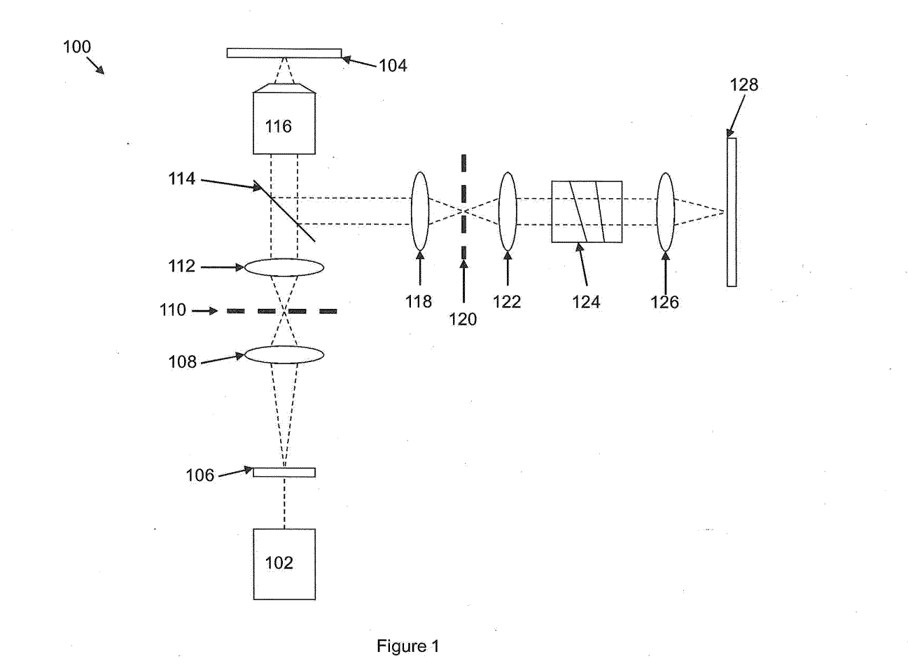

FIG. 1 provides a general schematic of the basic components of a fluorescence detection system of the present invention. As shown, the overall system 100 generally includes an excitation illumination source 102. Typically, such illumination sources will comprise high intensity light sources such as lasers or other high intensity sources such as LEDs, high intensity lamps (mercury, sodium or xenon lamps), laser diodes, and the like. In preferred aspects, the sources will have a relatively narrow spectral range and will include a focused and/or collimated or coherent beam. For the foregoing reasons, particularly preferred light sources include lasers, solid state laser diodes, and the like.

The excitation illumination source 102 is positioned to direct light of an appropriate excitation wavelength or wavelength range, at a desired fluorescent signal source, e.g., substrate 104, through an optical train. In accordance with the present invention, the optical train typically includes a number of elements to appropriately direct excitation illumination at the substrate 104, and receive and transmit emitted signals from the substrate to an appropriate detection system such as detector 128. In accordance with the present invention, the excitation illumination from illumination source 102 is directed first through an optical multiplex element 106, or elements, to multiply the number of illumination beams or spots from an individual beam or spot from the illumination source 102. The multiplexed beam(s) is then directed via focusing lens 108 through optional first spatial filter 110, and focusing lens 112. As discussed in greater detail below, spatial filter 110 optionally provides control over the extent of multiplex beams continuing through the optical train reduces the amount of any scattered excitation light from reaching the substrate. The spatially filtered excitation light is then passed through dichroic 114 into objective lens 116, whereupon the excitation light is focused upon the substrate 104. Dichroic 114 is configured to pass light of the spectrum of the excitation illumination while reflecting light having the spectrum of the emitted signals from the substrate 104. Because the excitation illumination is multiplexed into multiple beams, multiple discrete regions of the substrate are separately illuminated.

Fluorescent signals that are emitted from those portions of the substrate that are illuminated, are then collected through the objective lens 116, and, because of their differing spectral characteristics, they are reflected by dichroic 114, through focusing lens 118, and second spatial filter, such as confocal mask 120, and focusing lens 122. Confocal mask 120 is typically positioned in the focal plane of lens 118, so that only in-focus light is passed through the confocal mask, and out-of focus light components are blocked. This results in a substantial reduction in noise levels from the system, e.g., that derive from out of focus contributors, such as autofluorescence of the substrate and other system components.

As with the excitation illumination, the signals from the multiple discrete illuminated regions on the substrate are separately passed through the optical train. The fluorescent signals that have been subjected to spatial filtering are then passed through a dispersive optical element, such as prism assembly 124, to separately direct spectrally different fluorescent signal components, e.g., color separation, which separately directed signals are then passed through focusing lens 126 and focused upon detector 128, e.g., an imaging detector such as a CCD, ICCD, EMCCD or CMOS based detection element. Again, the spectrally separated components of each individual signal are separately imaged upon the detector, so that each signal from the substrate will be imaged as separate spectral components corresponding to that signal from the substrate. For a discussion of the spectral separation of discrete optical signals, see, e.g., Published U.S. Patent Application No. 2007-0036511, incorporated herein by reference in its entirety for all purposes.

As will be appreciated, a more conventional configuration that employs reflected excitation light and transmitted fluorescence may also be employed by altering the configuration of and around dichroic 114. In particular, dichroic 114 could be selected to be reflective of the excitation light from illumination source 102, and transmissive to fluorescence from the substrate 104. The various portions of the optical train are then arranged accordingly around dichroic 114. Notwithstanding the foregoing, fluorescence reflective optical trains are particularly preferred in the applications of the systems of the invention. For a discussion on the advantages of such systems, see, e.g., U.S. patent application Ser. Nos. 11/704,689, filed Feb. 9, 2007, 11/483,413, filed Jul. 7, 2006, and 11/704,733, filed Feb. 9, 2007, the full disclosures of which are incorporated herein by reference in their entirety for all purpose.

B. Multiplex Optics

A number of methods may be used to multiplex the optics in order to illuminate and/or observe multiple discrete sample regions simultaneously. For example, a broad illumination beam spot may be directed at a substrate upon which multiple signal sources are disposed, such that simultaneous illumination and fluorescence from multiple signal sources can be observed. Likewise, linear beam spot illumination profiles may be employed to illuminate signal sources that are disposed in a line, and thus detect fluorescent signals therefrom. While these aspects are effective for illuminating multiple discrete regions on a substrate, there are certain deficiencies associated with them, including excessive illumination and inefficient illumination power usage.

In accordance with preferred aspects of the present invention, systems are provided that separately illuminate large numbers of discrete regions on a substrate or discrete signal sources. As used herein, separate illumination of discrete regions or locations refers to multiple individual illumination spots that are separate from each other at least the resolution of optical microscopy. The systems of the invention provide the further advantage of providing such separate illumination of densely arrayed or arranged discrete regions. Such illumination patterns may provide discrete illumination spots at a density of on the order of at least 1000 discrete illumination spots per mm², preferably at least 10,000 discrete illumination spots per mm², and in some cases, greater than 100,000 discrete illumination spots per mm², or even 250,000 discrete illumination spots per mm² or more. As will be appreciated, the foregoing illumination pattern densities will typically result in intra-spot spacing upon an illuminated substrate (in the closest dimension), of less than 100 μm, center to center, preferably, less than 20 μm, more preferably, less than 10 μm, and in many preferred cases, spacing between spots of 1 μm or less, center to center. As noted previously, such spacing generally refers to inter-spot spacing in the closes dimension, and does not necessarily reflect inter-row spacing that may be substantially greater, due to the allowed spacing for spectral separation, of adjacent rows, as discussed elsewhere herein.

In accordance with the invention, the optical systems are generally capable of separately illuminating 100 or more discrete regions on a substrate, preferably greater than 500 discrete regions, more preferably greater than 1000 discrete regions, and still more preferably, greater than 5000 or more discrete regions. Further, such high number multiplex optics will preferably operate at the densities described above, e.g., from densities of about 1000 to about 1,000,000 discrete illumination spots per mm².

In preferred aspects, the illumination targets on the substrate will be regularly arranged over the substrate to be analyzed, e.g., provided in one or more columns and/or rows in a gridded array. Such regularly oriented target regions provide simplicity in production of the optical elements used in the system. Notwithstanding the foregoing, in many cases, the systems of the invention may be configured to direct excitation illumination in any of a variety of regular or irregular illumination patterns on the substrate. For example, in some cases, it may be desirable to target illumination at a plurality of regions that are arranged over the substrate in a non-repeating irregular spatial orientation. Accordingly, having identified such arrangement one could provide multiplex optics that direct excitation light accordingly.

In still other aspects, multiplex optics may be provided that direct in-focus illumination in a three dimensional space, thus allowing the systems of the invention to illuminate and detect signals from three dimensional substrates. Such substrates may include solid tissue samples, encases samples, bundles of substrates, e.g., capillaries or multilayer microfluidic devices, and the like.

A variety of components may be used to provide large numbers of illumination spots from a few, or a single illumination beam. As discussed in greater detail below, the multiplex optical element may comprise one, two, three, four or more discrete optical elements that work in conjunction to provide the desired level of multiplex as well as provide controllability of the direction of the multiplexed beams. For example and as discussed in greater detail below, one may use two or more diffraction gratings to first split a beam into a plurality of beams that will provide a plurality of collinear spots arrayed in a first dimension. Each of these beams may then be subjected to additional manipulation to provide a desired targeted illumination pattern. For example, each resulting beam may be passed through appropriate linearization optics, such as a cylindrical lens, to expand each collinear spot into an illumination line oriented orthogonal to the axis of the original series of spots. The result is the generation of a series of parallel illumination lines that may be directed at the substrate. Alternatively and preferably in some cases, the series of beams resulting from the first diffraction grating may be passed through a second diffraction grating that is rotated at a 90 degree angle (or other appropriate angle) to the first diffraction grating to provide a two dimensional array of illumination beams/spots, i.e., splitting each of the collinear spots into an orthogonally oriented series of collinear spots. In particular, if one provides a diffraction grating that provides equal amplitude to the different orders, and illuminates it with a laser beam, it will result in a row of illuminated spots, corresponding to discrete beams each traveling at a unique angle after they impinge on the grating. If a second similar grating is placed adjacent to the first but rotated by 90 degrees, it will provide a 2 dimensional grid of beamlets, each traveling with a unique angle (the 2 angles are referred to herein as θₓ and θ_{y}). If the 2 gratings are identical, a square grid will result, but if the 2 gratings have different period, a rectangular grid will result. By selecting each of the diffraction gratings and the angle of rotation of the two gratings relative to each other, one can adjust spacing between and/or positioning of the columns or rows of illumination spots in the array, as desired.

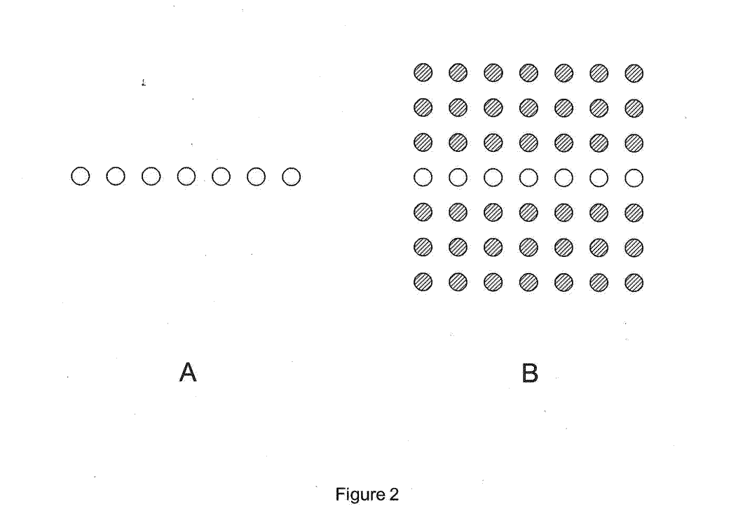

FIG. 2 provides a schematic illustration of the illumination pattern generated from a first diffraction grating, and for a first and second diffraction grating oriented 90° relative to each other. As shown, passing a single laser beam through an appropriate diffraction grating will give rise to multiple discrete beams (or “beamlets”) that are oriented in a collinear array and are represented in Panel A of FIG. 2 as a linear array of unfilled spots. By subsequently passing the linear array of beamlets through a second diffraction grating rotated orthogonally to the first, e.g., 90°, around the optical axis, one will convert each of the first set of beamlets (unfilled spots), into its own, orthogonally arrayed collinear array of beamlets (illustrated as hatched spots in Panel B of FIG. 2). The resulting set of beamlets results in a gridded array of spots, as shown inn Panel B of FIG. 2.

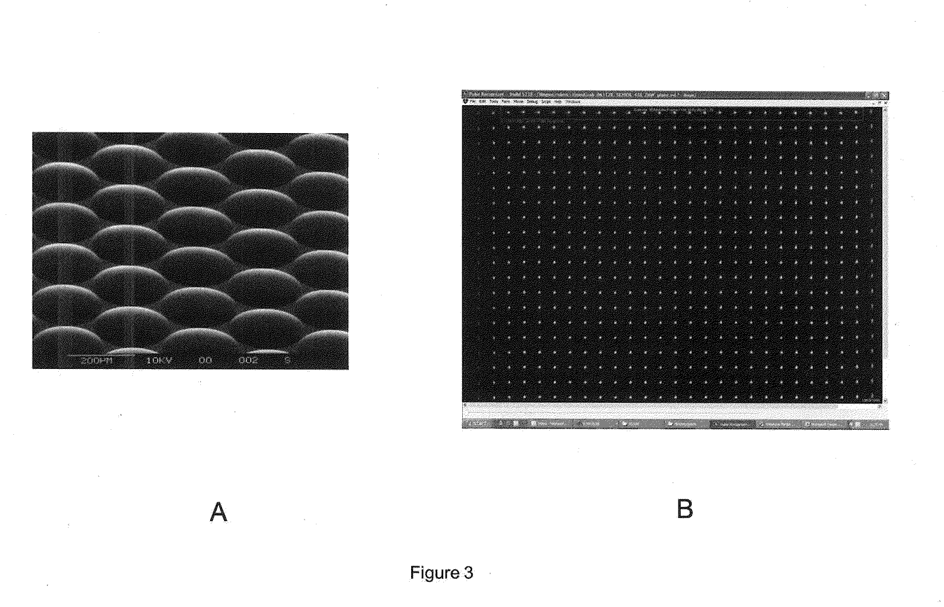

Alternate strategies employ microlens arrays to focus one or few originating illumination beams into multiple discrete beams that may be directed at substrates. For example, in a first aspect, excitation radiation may be directed through a microlens array in conjunction with the objective lens, in order to generate spot illumination for each of a number of illuminated regions on a substrate. In particular, a lens array can be used that would generate a gridded array of illumination spots that would be focused upon a gridded array of signal sources/reaction regions, such as zero mode waveguides, on a substrate. An example of a microlens array is shown in FIG. 3, Panel A. In particular, shown is an SEM image of the array. Panel B of FIG. 3 illustrates the illumination pattern from the microlens array used in conjunction with the objective lens of the system. As will be appreciated, the lens array is fabricated so as to be able to focus illumination spots on the same pitch and position as the locations on the array that are desired to be illuminated.

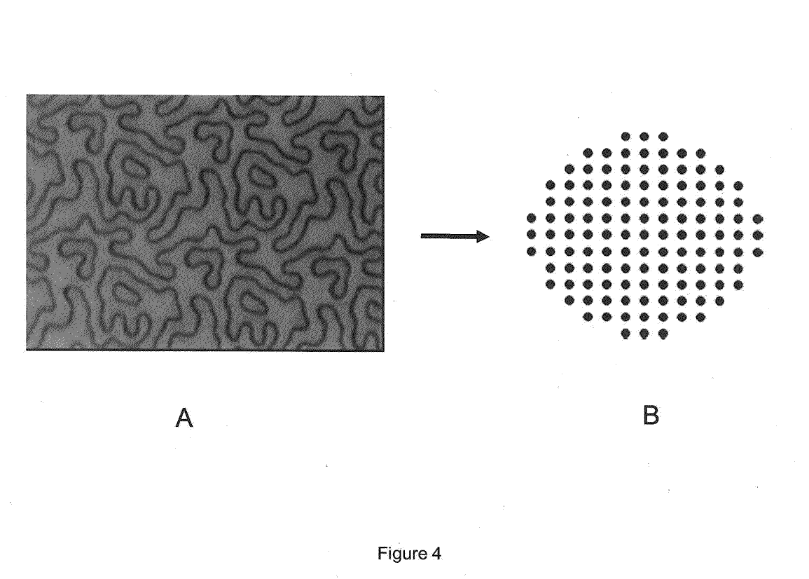

In alternate or additional aspects, the multiplex optics may include one or more diffractive optical elements (“DOE”) upstream of the objective lens, to generate a plurality of illumination spots for targeted illumination of signal sources from one or a few originating illumination beams. In particular, DOEs can be fabricated to provide complex illumination patterns, including arrays of large numbers of illumination spots that can, in turn, be focused upon large numbers of discrete targets. For example, as shown in FIG. 4, a DOE phase mask, as shown in Panel A, can generate a highly targeted illumination pattern, such as that shown in panel B, which provides targeted illumination of relatively large numbers of discrete locations on a substrate, simultaneously. In particular, the DOE equipped optical system can generally separately illuminate at least 100 discrete signal sources, e.g., zero mode waveguides, simultaneously and in a targeted illumination pattern. In preferred aspects, the DOE may be used to simultaneously illuminate at least 500 discrete signal sources, and in more preferred aspects, illuminate at least 1000, or from 1000 to about 5000, or in many cases at least 5000 or more discrete signal sources simultaneously, and in a targeted illumination pattern, e.g., without substantially illuminating other portions of a substrate, such as the space between adjacent signal sources.

Several approaches can be used to design and fabricate a DOE for use in the present invention. The purpose here is to evenly divide the single laser beam into a large number of discrete new beams, e.g., up to 5000 or more new beams, each with 1/5000 of the energy of the original beam, and each of the up to 5000 “beamlets” traveling in a different direction. By way of example, the DOE design requirement is to evenly space the beamlets in angles (the 2 angles are referred to herein as θₓ and θ_{y}).

As will be appreciated, the DOE will divide the light into numerous beams that are propagating at unique angles. In a preferred illumination scheme, and as noted above, the DOE is combined with the objective lens, such that the objective lens will perform a Fourier transform on all of the beamlets. In this Fourier transform, angle information is converted into special information at the image plane of the objective. After the beamlets pass through the objective, each unique θₓ and θ_{y} will correspond to a unique x,y location in the image plane of the objective. The objective properties are used to design the DOE or microlens. The formula for the Fourier transform is given by:

(x,y)=EFL×Tangent(θₓ,θ_{y}),

where EFL is the Effective Focal Length of the objective.

There are several different approaches to producing a DOE that will meet the needs of the invention. For example, one approach is through the use of a phase mask that is pixellated such that each pixel will retard the incident photons by a programmed amount. This phase retardation can again be achieved in different ways. For example, one preferred approach uses thickness of the glass element. For example, the phase mask might include a ½ inch square piece of SiO₂. Material is etched away from the top surface of the SiO₂ plate to, e.g., 64 different etch depths. This is referred to as a 64-level grey scale pattern. The final phase mask then is comprised of a pixellated grid where each pixel is etched to a particular depth. The range of etch depths corresponds to a full 2π of phase difference. Restated, a photon which impinges on a pixel with the minimum etch depth (no etching) will experience exactly 2π additional phase evolution compared to a photon which strikes a maximum etch depth (thinnest part of the SiO₂). The pixellated pattern etched into the DOE is repeated periodically; with the result that the lateral position of the laser beam impinging on the mask is unimportant.

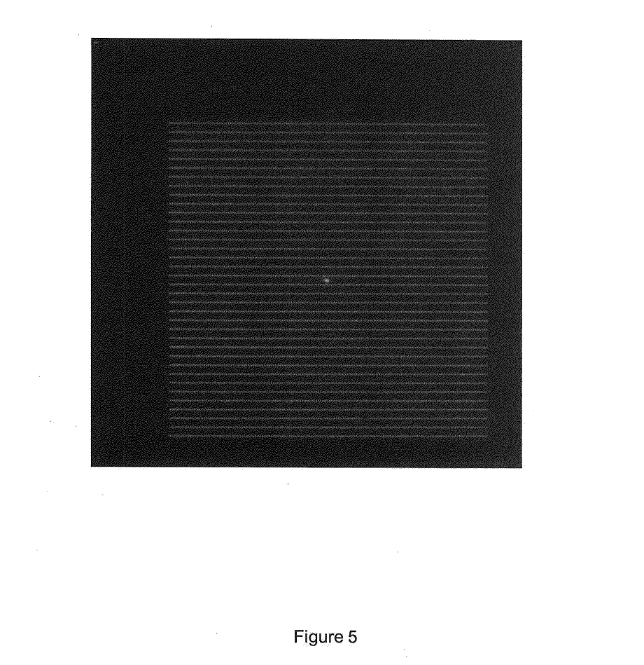

FIG. 5 shows an illumination pattern generated from a DOE that provides an array of 5112 discrete illumination spots. The DOE is configured such that the illumination spots are on a period that, when focused upon the substrate appropriately, will correspond to a discrete signal source in an arrayed substrate, e.g., a zero mode waveguide array.

In some cases, it may be desirable to provide illumination patterns that have a higher density of illumination spots than may be provided using a single DOE. In particular, the period size or spacing between adjacent illumination spots resulting from a DOE is a function of the minimum spot size of the originating illumination beam. As such, in order to obtain a higher density or smaller period size, for the illumination pattern, one may be required to employ an originating beam spot size that is smaller than desired, resulting in incomplete illumination of a desired target or enhanced difficulty in targeting a small spot to a small target. For example, in many cases, the originating beam size typically must be at least twice the period size between two adjacent resulting illumination spots from a DOE. However, where one desires an illumination spot of a larger size, the period is consequently increased.

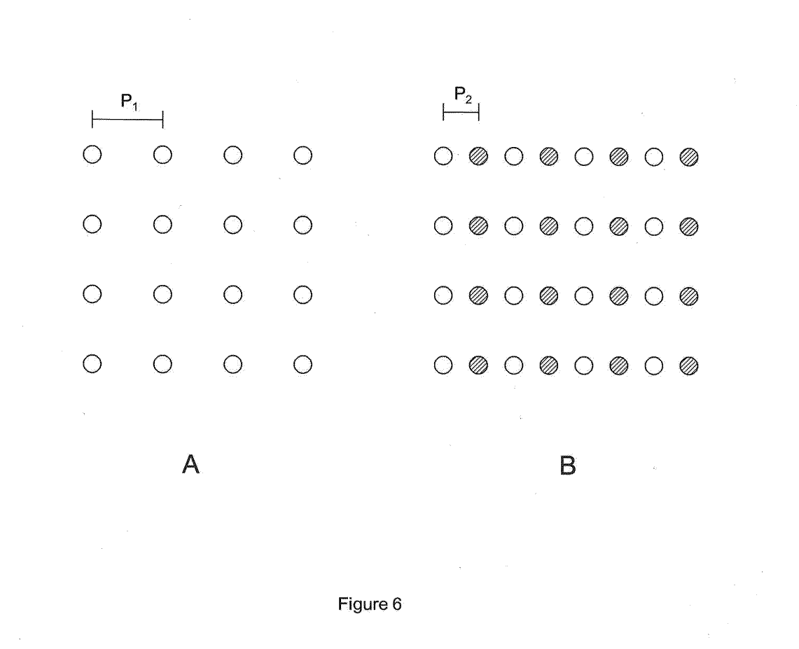

In addressing this issue, one particularly preferred approach is to utilize multiple multiplex elements in parallel (rather than in series). In particular, one may use two or more similar or identical DOEs in an illumination path where each DOE results in illumination spots at a period size that is twice that desired in one or more dimensions, but where each of which provides an illumination spot size that is desired. The originating beam is first split into two identical beams using, e.g., a 50% beam splitter. Each beam is then directed through its own copy of the DOE, and the resulting multiplexed beams are imaged one half a period off from each other. As a result, the period size of the illumination spots is half that obtained with a single DOE. FIG. 6 provides a schematic illustration of the resulting illumination pattern when the illumination pattern (unfilled spots) from a first DOE having a first period P₁ (shown in panel A) and a second DOE having the same illumination pattern period P1 (hatched spots) are overlaid as a single projection (shown in Panel B) having a new effective period P₂. As alluded to above, two, three, four or more DOEs may be used in parallel and their resulting spots overlaid, to provide different spot spacing regardless of the originating illumination spot size, providing spacing is maintained sufficient to avoid undesirable levels of spot overlap at the target locations. In addition, and as apparent in FIG. 6, by overlaying multiple illumination patterns, one can provide different spacing of illumination spots in one dimension while preserving the larger spacing. In particular, one can provide more densely arrayed illumination spots in rows while preserving a larger intra-row spacing. Such spacing is particularly useful where one wishes to preserve at least one dimension of larger spacing to account for spectral separation of signals emanating from each illuminated region. Such spacing is discussed in detail in, e.g., U.S. patent application Ser. Nos. 11/704,689, filed Feb. 9, 2007, 11/483,413, filed Jul. 7, 2006, and 11/704,733, filed Feb. 9, 2007, the full disclosures of which are incorporated herein by reference in their entirety for all purpose.

In addition to the foregoing considerations, and as will be appreciated, the actual phase evolution for the DOE is a function of the optical wavelength of the light being transmitted through it, so DOE devices will generally be provided for a specific wavelength of excitation illumination. As such, for applications of the systems of the invention in which broad spectrum or multispectral illumination is desired, the systems will typically include multiple multiplex elements, e.g., DOEs. For example, in the case of multispectral fluorescent analysis, different fluorescent dyes are typically excited at different wavelengths. As such, multiple different excitation light sources, e.g., lasers are used, e.g., one for each peak excitation spectrum of a dye. In such cases, a different multiplex element would preferably be provided for each illumination source. In the case of systems employing DOEs as the multiplex component for example, the optical path leading from each different laser would be equipped with its own DOE specially fabricated for that laser's spectrum. Accordingly, the systems of the invention will typically include at least one multiplex component, preferably, two, three or in many cases four or more different multiplex components to correspond to the at least one, preferably two, three, four or more different excitation light sources of varying illumination spectra.

In addition to accounting for variation in the excitation wavelength in the selection of the DOEs, the need for high density discrete illumination may also impact the DOE specifications. In particular, as will be appreciated, because adjacent beamlets or spots may be either perfectly in or out of phase with each other, any overlap between adjacent spots on a surface may be constructive, i.e., additive, or destructive, i.e., subtractive. As such, in particularly preferred aspects where uniform illumination of spots across the field of illumination spots, spots must be substantially separated with little or no overlap within the desired illumination region.

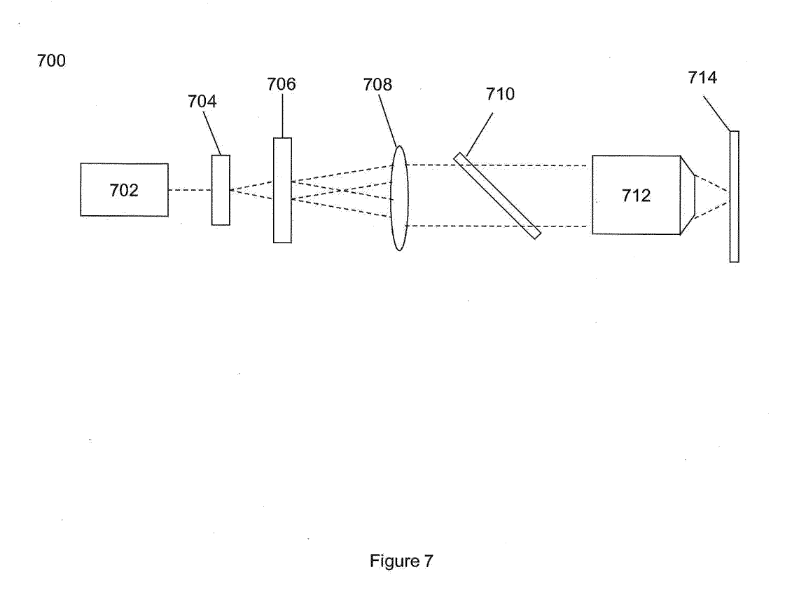

In alternative aspects, however, in conjunction with the multiple DOE approach described above, employ a polarization splitter to divide the originating beam into two or more separate beams of differing polarization. Each different beam may then be split into multiple beamlets that may be overlaid in closer proximity or with greater overlap without concern for destructive interference in the overlapping regions. While a conventional polarizing beam splitter may be used to divide the originating beam, in preferred aspects, a Wollaston prism may be employed. Wollaston prisms provide for a slightly different deviation angle for s and p polarizations, resulting in the generation of two closely spaced beamlets that may be directed through the same or multiple DOEs without concern for interference from overlapping beamlets. In addition to avoiding an interference issue, the use of the Wollaston prism provides additional control of the intra-illumination spot spacing. In particular, by rotating the prism, one can adjust the spacing between grids of beamlets generated from passing the two or more different polar beam components through the DOE(s). An example of an illumination optical path including this configuration is illustrated in FIG. 7. For ease of discussion, the fluorescence path is omitted from FIG. 7. As shown, the illumination path 700 includes excitation light source 702. The excitation light is directed through polarizing splitter such as a Wollaston prism 704 which splits the originating beam into its polar p and s components. Each polar beam is then passed through a multiplex component, such as one or more DOEs 704. These doubled multiplexed beams are then passed through lens 706, dichroic 710 and objective 712, to be focused as an array of illumination spots on substrate 714. As with FIG. 6, the array of illumination spots comprise overlaid patterns separated by the separation imparted by the Wollaston prism 704. Further, by rotating the prism 704, one can modulate the separation between the overlaid polar illumination patterns to adjust intra-spot spacing.

As noted above, in some cases, it may be desirable to direct excitation illumination at targets that exist in three dimensional space, as opposed to merely on a planar substrate. In such cases, DOEs may be readily designed to convert an originating beam into an array of beamlets with different focal planes, so as to provide for three dimensional illumination and interrogation of three dimensional substrates, such as layered fluidic structures (See, U.S. Pat. No. 6,857,449) capillary bundles, or other solid structures that would be subjected to illuminated analysis.

For many applications the desired intensity of the different beamlets could be variable. For example, it may be advantageous to prescribe a varying pattern of intensities to provide a variable range of intensities that can be sampled by a grid of cells. Or, the desired intensity could be selected in real time by moving the sample to a beamlet of the desired intensity. Or, the grid of variable intensities could be in a repeating pattern such that a grid of sample cells with the periodicity of the repeating pattern, and the intensity of the entire grid can be selected by moving to the desired location. More importantly, variations in optical throughput can be compensated by programming the beamlet intensity. In most optical systems light near the edges of the field-of-view is vignetted such that the optical transmission is maximum at the center and falls off slowly as the observation point moves away from the center. Ina typical system based on an objective lens, the vignetting may because 10% lower throughput at the edge of the optical field. In this case, the DOE beamlet intensity pattern can be pre-programmed to be 10% higher at the edge of the field than the center, and to vary smoothly according to the vignetting. More complicated variations in throughput can also exist in particular optical systems, and can be pre-compensated in the DOEE design. The details of how to design the DOE phase mask are described in the following reference: “Digital Diffractive optics” by Bernard Kress and Patrick Meyrueis, Wiley 2000.

Accordingly, one may provide DOEs that present multiplexed beamlets that have ranges of different powers or intensities. In particular, the DOE may be designed and configured to present beamlets that differ in their respective power levels. As such, at least two beamlets presented will typically have different power levels, and in some cases larger subsets (e.g., 10 or more beamlets), or all of the presented beamlets may be at different power levels as a result of configuration of the DOE. Restated, a DOE can generate beamlets having power profiles to fit a given application, e.g., correcting for optical aberrations such as vignetting, providing a range of illumination intensities across a substrate, and the like. The resulting beamlets may fall within two, 5, 10, 20 or more different power profiles.

When the DOE beamlet pattern is used in combination with a microscope objective lens, the size of the individual beamlets can be modified as desired by 1) adjusting the diameter of the barn into the DOE and 2) defocusing the pattern slightly. In the case of 1) the size of the beamlet is a function of the size of the input beam, and increasing the input beam size will decrease the beamlet size. In any case the final beamlet size at the ZMW plane obeys the diffraction limit, which is affected by the aperture size, and changing the input beam diameter is equivalent to changing the aperture related to the optical diffraction limit. In the case of defocusing the entire pattern, the diffraction limit is no longer obeyed but the beamlets can be made to have larger size than the diffraction limit. Further, the beamlets need not be circular—they could be elliptical by either starting with an elliptical beam input into the DOE or by defocusing the pattern in 1 or both dimensions. The reference here is “Principles of Optics” by Born and Wolf, Wiley, 2006 edition.

Alternative multiplex optics systems for converting a single illumination source into multiple targeted illumination beams includes, for example fiber optic approaches, where excitation light is directed through multiple discrete optical fibers that are, in turn directed at the substrate, e.g., through the remainder of the optical train, e.g., the objective. In such context, the fiber bundles are positioned to deliver excitation illumination in accordance with a desired pattern, such as a gridded array of illumination spots.

In addition to multiplex optics that convert a single illumination beam into multiple discrete beams, as described above, certain aspects of the present invention may employ multiplexed illumination sources in place of a single illumination source with a separate multiplex optic component to split the illumination into multiple beamlets. Such systems are particularly useful in combination with the spatial filters described in greater detail below, and include, for example, arrayed solid state illumination sources, such as LEDs, diode lasers, and the like.

C. Spatial Filters

In addition to the ability to separately illuminate large numbers of densely arrayed discrete regions of a substrate, the systems of the invention provide the further advantage of being able to simultaneously and separately collect and detect optical signals from each of such regions, e.g., fluorescent emissions emanating from each such region. In the systems of the invention, the collected signals from each of these signal sources is subjected to a spatial filtering process whereby light noise contributions that are not within the focal plane of the optical system are minimized or eliminated. In preferred aspects, this is accomplished by placing a confocal filter within the optical train. In particular, the fluorescent signals from the discrete regions on the substrate that are collected by the objective and transmitted through the optical train, are passed through a focusing or field lens and a confocal filter placed in the image plane of that lens. The light passed through the confocal filter is subsequently refocused and imaged onto a detector. Fluorescence that is not in the focal plane of the objective will be blocked by the confocal aperture, and as a result, will not reach the detector, and consequently will not contribute to the fluorescent noise. This typically includes scattered or reflected fluorescence, autofluorescence of substrates and other system components and the like. In the context of the present invention, the spatial filtering process is applied to the fluorescent signals from a large number of discrete signal sources, simultaneously, e.g., without the use of scanning, galvo or other rastering systems. In particular, the confocal filters applied in the systems of the invention typically include a large number of confocal apertures that correspond to the number of regions on the substrate from which signals are desired to be obtained. As such, the confocal masks used in this context will typically include an array of at least about 100 or more discrete confocal apertures, preferably greater than 500 discrete confocal apertures, more preferably greater than 1000 discrete confocal apertures, and still more preferably, between about 1000 and about 5000 apertures, and in some cases greater than 5000 or more discrete confocal apertures. Such confocal masks will also typically be arrayed in a concordant pitch and/or alignment with the signal source arrays, so that signal from each discrete source that is desired to be observed will pass through a separate confocal aperture in the confocal mask. The actual size and spacing of the confocal pinholes will typically vary depending upon the desired illumination pattern, e.g., number and spacing of illumination beamlets, as well as the characteristics of the optical system.

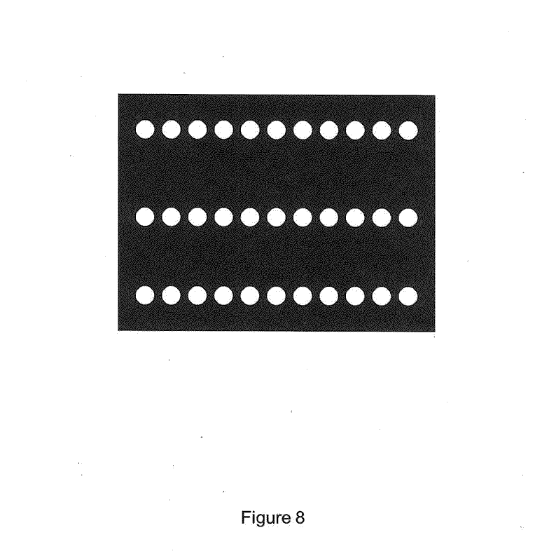

While individual pinhole apertures corresponding to individual signal sources are generally preferred, it will be appreciated that other spatial filters may also be employed that provide for simpler alignment, such as using narrow slits to reduce out of focus signal components in at least one dimension. Individual slits could be employed in filtering signals from a plurality of signal sources in a given row, column or other defined region, e.g., adjacent signal sources on the diagonal. FIG. 8 shows a schematic of a partial confocal mask showing apertures that are provided on the same pitch and arrangement as the signals being focused therethrough, e.g., corresponding to fluorescent signals imaged from an array of zero mode waveguides.

D. Spectral Separation and Detection

As noted with reference to FIG. 1, the fluorescence path of the system typically includes optics for focusing the signals from the various regions onto discrete locations on a detector. As with the direction of excitation illumination onto a plurality of discrete regions on a relatively small substrate area, likewise, each of the plurality of discrete fluorescent signals is separately imaged onto discrete locations on a relatively small detector area. This is generally accomplished through focusing optics in the fluorescence path positioned between the confocal filter and the detector (optionally in combination with optical components provided with the confocal filter (see discussion below). As with the illumination path, the fluorescence path will typically direct at least 10, preferably at least 100, more preferably at least 500, or 1000 or in some cases at least 5000 discrete fluorescent signals to discrete locations on the detector. Because these detectors, e.g., EMCCDs have relatively small areas, these signals will typically be imaged at relatively high densities (at the EMCCD plane. Such densities typically reflect the illumination spot density at the substrate plane divided by the relative size of image of the substrate as compared to the actual substrate size, due to magnification of the system, e.g., imaging signal sources on an area that is 3600× larger than the illumination pattern (e.g., 250,000 illumination density/3600). Although in preferred aspects, the images of the fluorescent signal components will be oriented in an array of two or more rows and/or columns of imaged signals, in order to provide the densities set forth herein, it will be appreciated that density may be determined from images arrayed in other formats, such as linear arrays, random arrays, and the like. Further, while the imaged signals of the invention will preferably number greater than 10, 100, 500, 1000 or even greater than 5000, density may be readily determined and applicable to as few as two discrete images, provided such images are sufficiently proximal to each other to fit within the density described.

The systems of the invention also typically include spectral separation optics to separately direct different spectral components of the fluorescent signals emanating from each of the discrete regions or locations on the substrate, and image such spectral components onto the detector. In some eases, the image of the spectral components of a given discrete fluorescent signal will be completely separate from each other. In such cases, it will be appreciated that the density of the discrete images on the detector may be increased by the number of discrete fluorescent components. For or example, where a fluorescent signal is separated into four spectral components, each of which is discretely imaged upon the detector, such density could be up to 4 times that set forth above. In preferred aspects, however, the separate direction of spectral components from a given fluorescent signal will not impinge upon completely discrete regions of the detector, e.g., image of one spectral component would impinge on overlapping portions of the detector as another spectrally distinct component (See, e.g., Published U.S. Patent Application No. 2007-0036511 U.S. patent application Ser. Nos. 11/704,689, filed Feb. 9, 2007, 11/483,413, filed Jul. 7, 2006, and 11/704,733, filed Feb. 9, 2007, the full disclosures of which are incorporated herein by reference in their entirety for all purposes.

While the separation optics may include multiple elements such as filter/mirror combinations to separately direct spectrally distinct components of each fluorescent signal, in preferred aspects, a dispersive optical element is used to separately direct the different spectral components of the fluorescent signals to different locations on the substrate.

E. Beam Shaping

In addition to providing large numbers of discrete beams to be directed at arrayed regions on substrates, the systems of the invention optionally include additional components that provide controlled beam shaping functionalities, in order to present optimal illumination for a given application.

For example, in the case of systems employing lens arrays, such lens arrays may comprise a rectangular shape that results in illumination spots that are asymmetrically shaped, e.g., elliptical. Accordingly, one may include within the illumination path, one or more relatively shallow cylindrical lenses to correct the beam shape and provide a more symmetrical spot.

F. Additional Optical Components

In addition to the various optical components described above, a number of additional cooperating optical elements may be employed with lens arrays in order to provide finer tuning of the resulting illumination pattern emanating from the multiplex component or components of the systems of the invention

In a number of cases, it will be desirable to control, and preferably independently control the direction of individual beams or subsets of beams that have been multiplexed using the systems described herein. In particular, preferred applications of the systems of the invention will direct multiple beams at arrays of targets that are on a pre-selected spacing, orientation and pitch. However in some cases, the spacing, orientation and/or pitch of target regions may not be precisely known at the time of designing the optical path, and/or may be subject to change over time. Accordingly, in some cases it will be desired to provide for independent adjustment of the direction of individual beams, or more routinely subsets of beams multiplexed from a single originating beam.

By way of example, in the case of arrays of discrete reaction regions, typically such reaction regions will be provided at substantially known relative locations, pitch and orientation. In particular, such arrays may generally be presented in a gridded format of regularly spaced columns and/or rows. However, variations in the processes used to create such arrays may result in variations in such relative location, within prescribed tolerances. This is particularly an issue where the features of such arrays are on the scale of nanometers, e.g., from 10 to 500 nm in cross section.

For example, in the case of linear illumination patterns, one may wish to adjust the intra-line spacing of the illumination pattern. One particular approach involves the case where a series of parallel illumination lines is created from the linearization of a row of co-linear beamlets or spots. In particular, a collinear arrangement of illumination spots generated by passing a single illumination beam through, e.g., a diffraction grating or DOE, may be converted to a series of parallel illumination lines by directing the beams through one or more cylindrical lenses. Accordingly, by simply rotating the diffraction grating or DOE around its optical axis, one can adjust the spacing of the illumination lines emanating from the cylindrical lens(es).

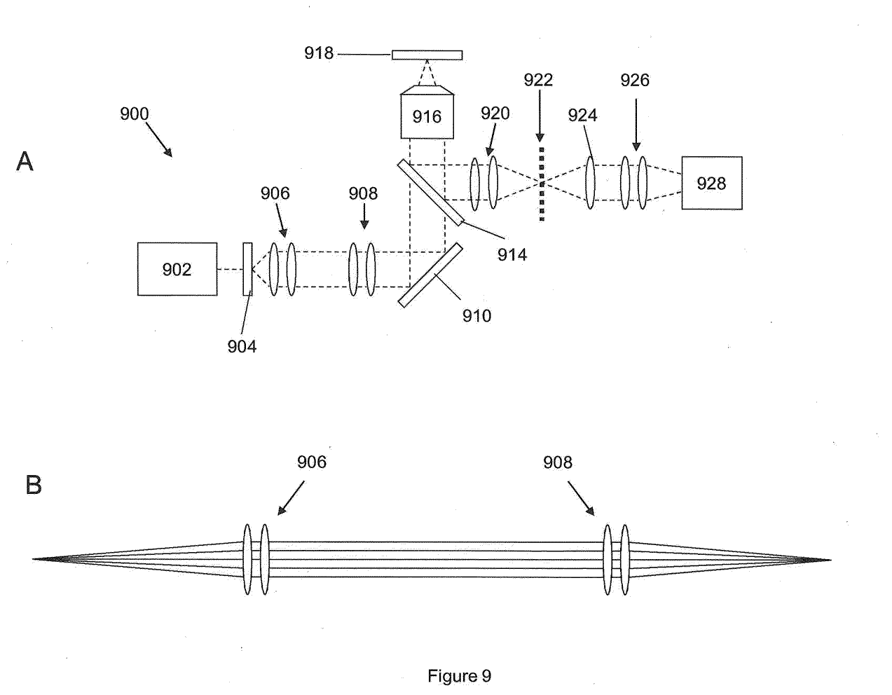

For example, in some cases, it may be desirable to provide tunable lens or lenses between the multiplex component(s) and the objective of the system, in order to compensate for potential focal length variation or distortion in the objective. Such lenses may include, for example, a zoomable tube lens having a variable focal length that may be adjusted as needed. Alternatively, additional pairs of field lenses may be employed that are adjustable relative to each other, in order to provide the variable focal length. In addition to the foregoing advantages, the use of such field lenses also provide for: transformation of diverging beamlets from DOEs or other multiplex elements, into converging beamlets into the objective (as shown in FIG. 9, Panel B); provide the ability to finely adjust the angular separation of the beamlets; and provide an intermediate focusing plane so that additional elements can be incorporated, such as additional spatial filters. For example either in conjunction with field lenses as set forth above, or in some cases, in their absence, spatial filters may be applied in the illumination path.

A schematic illustration of a system employing such pairs of field lenses is shown in FIG. 9. As shown, the excitation illumination source 902 directs the originating beam through the multiplex component(s) such as DOE 904 to create multiple beamlets. The beamlets are then passed through a pair of lenses or lens doublets, such as doublets 906 and 908. As noted above, the lens pair or doublet pairs 906 and 908, provide a number of control options over the illumination beams. For example, as shown in Panel B to FIG. 9, these doublet pairs can convert diverging beamlets into converging beamlets in advance of passing into objective 916. Likewise, such doublet pairs may be configured to adjust the angular separation of the beamlets emanating from DOE 904. In particular, by adjusting spacing between lenses in each doublet, one can magnify the angle of separation between beamlets. One example of this is shown in the table, below, that provides the calculated angular magnification from adjustment of spacing between lenses in each doublet of a pair of exemplary doublet lenses, e.g., corresponding to the lenses in doublets 906 and 908 of FIG. 9.

| Spacing in | Spacing in | | | |
|---|---|---|---|---|
| First | Second | Incoming | Outgoing | |
| Doublet | Doublet | Beamlet | Beamlet | Angular |
| (mm) | (mm) | Angle (°) | Angle (°) | Magnification |
| 2 | 0 | 2.5505 | −2.4234 | −0.95 |
| 1 | 0 | 2.5505 | −2.48858 | −0.97 |
| 0 | 0 | 2.5505 | −2.5505 | −1.00 |
| 0 | 1 | 2.5505 | −2.6161 | −1.03 |
| 0 | 2 | 2.5505 | −2.6816 | −1.05 |

Additionally, an optional spatial filter (as shown FIG. 1 as spatial filter 110) may be provided between the doublets 906 and 908, to provide modulation of the beamlets as described elsewhere herein.

The beamlets are then directed through dichroic 914, e.g., by reflecting off optional directional mirror 910, and through objective 916, which focuses the illumination pattern of the beamlets onto substrate 918. Fluorescent emissions from each discrete location that is illuminated by the discrete beamlets are then collected by the objective 916 and reflected off dichroic 914 to pass into the separate portion of the fluorescence path of the system. The fluorescent signals are then focused by focusing or field lens, e.g., shown as a doublet lens 920, through a spatial filter such as confocal mask 922, that is positioned in the focal plane of lens doublet 920, so that only in focus fluorescence is passed. Doublet 920 is preferably paired with objective 916 to provide optimal image quality (both at the confocal plane and the detector image plane). The confocally filtered fluorescence is then refocused using field lens 924 and is focused onto detector 928 using another focusing lens or lens doublet, such as doublet 926. By providing a doublet focusing lens, one again yields advantages of controllability as applied to the fluorescent signals.

In addition to independent adjustment of subsets of beams multiplexed from a single originating beam, it may also be desirable to independently adjust subsets of signals emanating from a substrate in response to illumination. In particular, in some cases, it may be desirable to selectively adjust certain subsets of signals in order to direct them through selected regions of the optical train, e.g., aligning with confocal masks, or to direct such signals to desired detector regions. In general, adjusting the direction of the multiple discrete fluorescent signals may be accomplished using substantially the same methods and components as those described for use in the adjustment of the excitation beams.

The use of spatial filters in the illumination path can provide a number of control advantages for the system, including dynamic and uniform control over the multiplex illumination pattern. In particular, one can employ a simple aperture or iris shaped or shapeable to narrow the array of beamlets that reaches the objective, and consequently the substrate. As a result, one can narrowly tailor the illumination pattern to avoid extraneous illumination of the substrate, or to target a sub-set of illumination regions or sub-region of an overall substrate. More complex spatial filters may also be employed to target different and diverse patterns of regions on the substrate by providing a mask element that permits those beamlets that correspond to the desired illumination pattern on the substrate. For example, one could target different rows and/or columns of reaction regions on an arrayed substrate, to monitor different reactions and/or different time points of similar reactions, and the like. As will be appreciated, through the use of controllable apertures, e.g., apertures that may be adjusted in situ to permit more, fewer, or different beamlets pass to the objective and ultimately the substrate, one could vary the illumination patterns dynamically to achieve a variety of desired goals.

Other types of optical elements also may be included within the illumination path. For example, in some cases, it may be desirable to include filters that modulate laser power intensity that reaches the objective. Such filters may include uniform field filters, e.g., modulating substantially all beamlets to the same extent, or they may include filters that are pixellated to different levels of a gray scale to apply adjusted modulation to different beamlets in an array. Such differential modulation may be employed to provide a gradient of illumination over a given substrate or portion of a substrate, or it may be used to correct for power variations in beamlets as a result of aberrations in the multiplex optics, or other components of the optical train, or it may be used to actively screen off or actively adjust the modulation of illumination at individual or subsets of illumination targets. As will be appreciated, LCD based filters can be employed that would provide active control on a pixel by pixel basis.

Any of a variety of other optical elements may similarly be included in the illumination path depending upon the desired application, including, for example, polarization filters to adjust the polarization of the illumination light reaching the substrate, scanning elements, such as galvanometers, rotating mirrors or prisms or other rastering optics such as oscilating mirrors or prisms, that may provide for highly multiplexed scanning systems, compensation optics to correct for optical aberrations of the system, e.g., vignetting, patterned spectral filters that can direct illumination light of different spectral characteristics to different portions of a given substrate, and the like.

In particular, such spatial filter may be configured to block extraneous beamlets resulting from the diffractive orders of the multiplex components, which extraneous beamlets may contribute to noise issues. By way of example, a simple square or rectangular aperture may be provided in the illumination path after the multiplex component to permit only a limited array of beamlets to pass ultimately to the objective and substrate. Further, additional and potentially more complex spatial filters may be used to selectively illuminate portions of the substrate, which filters may be switched out in operation to alter the illumination profile. As noted above, the use of such fine tuning optical components may be included not only in the illumination path of the system, but also in the fluorescence transmission path of the system.

Although described as including various components of both an illumination path and a fluorescence path, it will be appreciated that certain aspects of the invention do not require all elements of both paths as described above. For example, in certain aspects, spectral separation of fluorescent signals may not be desirable or needed, and as such may be omitted from the systems of the invention. Likewise, in other aspects, optical signals from a substrate may not be based upon fluorescence, but may instead be based upon reflected light from the illumination source or transmitted light from the illumination source. In either case, the optical train may be configured to collect and detect such light based upon known techniques. For example, in the case of the detection of transmitted light, a light collection path may be set up that effectively duplicates the fluorescence path shown in the Figures hereto, but which is set up at a position relative to the sample opposite to that of the illumination path. Such path would typically include the objective, focusing optics, and optionally spectral filters and or confocal filters to modify the detected transmitted light, e.g., reduce scattering and autofluorescence. In such cases, dichroic filters may again, not be desired or needed.

### III. Applications

As noted previously, the systems, methods and processes of the invention are broadly applicable to a wide variety of applications where it is desirable to illuminate multiple discrete regions of a substrate and obtain responsive optical signals from such regions. Such applications include analysis of fluorescent or other optically monitored reactions or other processes, optical interrogation of, e.g., digital optical media, spatial characterization, e.g., holography, laser driven rapid prototyping techniques, multipoint spatial analysis, e.g., for mobility/motility analysis, as well as a large number of other general uses.

In one particularly preferred example, the methods and systems of the invention are applied in the analysis of nucleic acid sequencing reactions being carried out in arrays of optically confined reaction regions, such as zero mode waveguides. In particular, the methods and systems are useful for analyzing fluorescent signals that are indicative of incorporation of nucleotides during a template dependent polymerase mediated primer extension reaction, where the fluorescent signals are not just indicative of the incorporation event but also can be indicative of the type of nucleotide incorporated, and as a result, the underlying sequence of the template nucleic acid. Such nucleic acid sequencing processes are generally referred to as “sequencing by incorporation” or sequencing by synthesis” methods, in that sequence information is determined from the incorporation of nucleotides during nascent strand synthesis. Although the systems and methods of the invention are much more broadly applicable than this preferred application, the advantages and benefits of these systems and methods are exploited to a great degree in such applications. As such, for ease of discussion, the systems and methods of the invention are described in greater detail with respect to such applications, although they will be appreciated as having much broader applicability.

Typically, in sequencing by synthesis processes, a complex of a polymerase enzyme, a target template nucleic acid sequence and a primer sequence is provided. The complex is generally immobilized via the template, the primer, the polymerase or combinations of these. When the complex comes into contact with a nucleotide that is complementary to the base in the template sequence immediately adjacent to where the primer sequence is hybridized to that template, the polymerase will typically incorporate that nucleotide into the extended primer. By associating a fluorescent label with the nucleotide, one can identify the incorporation event by virtue of the presence of the label within the complex. In most SBI applications, the incorporation event terminates primer extension by virtue of a blocked 3′ group on the newly incorporated nucleotide. This generally allows the immobilized complex to be washed to remove any non-incorporated label, and observed, to identify the presence of the label. Subsequent to identifying incorporation, the complex is typically treated to remove any terminating blocking group and/or label group from the complex so that subsequent base incorporations can be observed. In some processes, a single type of base is added to the complex at a time and whether or not it is incorporated is determined. This typically requires iterative cycling through the four bases to identify extended sequence stretches. In alternative aspects, the four different bases are differentially labeled with four different fluorescent dyes that are spectrally distinguishable, e.g., by virtue of detectably different emission spectra. This allows simultaneous interrogation of the complex with all four bases to provide for an incorporation even in each cycle, and also provide for the identification of the base that was incorporated, by virtue of its unique spectral signature from its own label. In general, such systems still typically require addition of a terminated nucleotide followed by a washing step in order to identify the incorporated nucleotide.

In another approach, nucleotide incorporation is monitored in real time by optically confining the complex such that a single molecular complex may be observed. Upon incorporation, a characteristics signal associated with incorporation of a labeled nucleotide, is observed. Further, such systems typically employ a label that is removed during the incorporation process, e.g., a label coupled to the polyphosphate chain of a nucleotide or nucleotide analog, such that additive labeling effects do not occur. In particular, such optical confinements typically provide illumination of very small volumes at or near a surface to thereby restrict the amount of reagent that is subject to illumination to at or near the complex. As a result, labeled nucleotides that are associated with the complex, e.g., during incorporation, can yield a distinct signal indicative of that association. Examples of optical confinement techniques include, for example, total internal reflection fluorescence (TIRF) microscopy, where illumination light is directed at the substrate in a manner that causes substantially all of the light to be internally reflected within the substrate except for an evanescent wave very near to the surface.

Other preferred optical confinement techniques include the use of zero mode waveguide structures as the location for the reaction of interest. Briefly, such zero mode waveguides comprise a cladding layer disposed over a transparent substrate layer with core regions disposed through the cladding layer to the transparent substrate. Because the cores have a cross-sectional dimension in the nanometer range, e.g., from about 10 to about 200 nm, they prevent propagation of certain light through the core, e.g., light that is greater than the cut-off frequency for the given cross-sectional dimension for such core. As a result, and as with the TIRF confinement, light entering the waveguide core through one or the other end, is subject to evanescent decay, that results in only a very small illumination volume at the end of the core from which the light enters.

In the context of SBI applications, immobilizing the complex at one end of the core, e.g., on the transparent substrate, allows for illumination of the very small volume that includes the immobilized complex, and thus the ability to monitor few or individual complexes. Because these systems focus upon individual molecular interactions, they typically rely upon very low levels of available signal. This in turn necessitates more sensitive detection components. Further, in interrogating large numbers of different reactions, one must apply a relatively large amount of illumination radiation to the substrate, e.g., to provide adequate illumination to multiple reaction regions. As a result, there is the potentiality for very low signal levels coming from individual molecules coupled with very high noise levels coming from highly illuminated substrates and systems and sensitive optical detection systems.

Although described primarily in terms of single molecule analysis, and particularly for sequence determination applications, the systems of the invention, with their highly multiplexed confocal optics, are useful in almost any application in which one wishes to interrogate multiple samples for a fluorescent signal or signals. For example, in related research fields, the systems of the invention are directly applicable to the optical interrogation of arrays of biological reactions and/or reactants. These may range from the simple embodiment of a highly multiplexed multiwell reaction plates, e.g., 96, 386 or 1536 well plates, or higher multiplexed “nanoplates”, such as the Openarray® plates from Biotrove, Inc., to the more complex systems of spotted or in-situ synthesized high density molecular or biological arrays. In particular, biological arrays typically comprise relatively high density spots or patches of molecules of interest that are interrogated with and analyzed for the ability to interact with other molecules, e.g., probes, which bear fluorescent labeling groups. Such arrays typically employ any of a variety of molecule types for which one may desire to interrogate another molecule for its interaction therewith. These may include oligonucleotide arrays, such as the Genechip® systems available from Affymetrix, Inc (Santa Clara, Calif.), protein arrays that include antibodies, antibody fragments, receptor proteins, enzymes, or the like, or any of a variety of other biologically relevant molecule systems.

In its most prolific application, array technology employs arrays of different oligonucleotide molecules that are arrayed on a surface such that different locations, spots or features have sequences that are known based upon their position on the array. The array is then interrogated with a target sequence, e.g., an unknown sample sequence, that bears a fluorescent label. The identity of at least a portion of that target sequence is then determinable from the probe with which it hybridizes, which is, in turn, known or determinable from the position on the array from which the fluorescent signal emanates.

As feature sizes in arrays are reduced in order to provide greater numbers of molecules, the needs for highly multiplexed systems of the invention are increased. Likewise, as array sizes increase, the demands on conventional scanning systems are further increased. As such, the systems of the invention, either as static array illumination, or as scanning or otherwise translatable systems, as described above, are particularly useful in this regard.

In commercially available systems, interrogation of large arrays of molecules has been carried out through either the use of image capture systems, or through the iterative scanning of the various spots or features of the array using, e.g., confocal scanning microscopes. The systems of the present invention, in contrast, provide a simultaneous, confocal examination of highly multiplexed arrays of different molecules through their discrete illumination and signal collection. Further, the spectroscopic aspects of the invention further enhance this functionality in the context of multi-label applications, e.g., where different targets/probes are labeled with spectrally distinguishable fluorescent labels.

The systems of the invention are similarly useful in a variety of other multiplexed spectroscopic analyses. For example, in the field of microfluidic systems, large numbers of microfluidic conduits may be arrayed and analyzed using the systems of the invention. Such microfluidic systems typically comprise fluidic conduits disposed within a glass or plastic substrate, through which reagents are moved, either electrokinetically or under pressure. As reagents flow past a detection point, they are interrogated with an excitation source, e.g., a laser spot, and the fluorescence is monitored. Examples of microfluidic systems include, for example, capillary array electrophoresis systems, e.g., as sold by Applied Biosystems Division of Applera, Inc., as well as monolithic systems, such as the LabChip® microfluidic systems available from Caliper Life Sciences, Inc. (Hopkinton, Mass.), and the Biomark™ and Topaz® systems available from Fluidigm®, Inc. (So. San Francisco, Calif.). While the fluidic conduits of these systems are predominantly arrayed in two dimensions, e.g., in a planar format, the systems of the invention may be configured to provide confocal illumination and detection from a three dimensional array of signal sources. In particular, diffractive optical elements used in certain aspects of the multiplex optics of the invention may be configured to provide illumination spots that are all in focus in a three dimensional array. Such three dimensional arrays may include multilayer microfluidic systems, bundled capillary systems, stacked multiwell reaction plates, or the like.

In addition to the foregoing, these systems are similarly applicable to any of a variety of other biological analyses, including, for example, multiplexed flow cytometry systems, multiplexed in-vivo imaging, e.g., imaging large numbers of different locations on a given organism, or multiple organisms (using, e.g., infrared illumination sources, e.g., as provided in the Ivis® series of imaging products from Caliper Life Sciences, Inc.

While the primary applications for the systems of the invention are geared toward multiplexed analysis of chemical, biochemical and biological applications, it will be appreciated that the highly multiplexed systems of the invention, with their high signal to noise capability, also find use, in whole or in part, in a variety of other optical interrogation techniques. For example, the highly multiplexed confocal optics and detection methods of the invention may be readily employed in high bandwidth reading and/or writing of digital data to or from optical media. Likewise, the highly multiplexed illumination systems of the invention may be employed in optically driven tools, such as laser based rapid prototyping techniques, parallel lithography techniques, and the like, where highly multiplexed laser beams can be applied in the fabrication and/or design processes.

Although described in some detail for purposes of illustration, it will be readily appreciated that a number of variations known or appreciated by those of skill in the art may be practiced within the scope of present invention. To the extent not already expressly incorporated herein, all published references and patent documents referred to in this disclosure are incorporated herein by reference in their entirety for all purposes.

What is claimed is:

1. An analytical system comprising:
a substrate comprising an array of at least 500 discrete signal sources, the array of discrete signal sources having a pitch P2,
an optical train for directing excitation light from an excitation source to the substrate and for receiving emitted light from the substrate and directing the emitted light to a detector;
wherein the optical train comprises at least one diffractive optical element which divides the light from the excitation source into an array of illumination spots on the substrate, the array of illumination spots having a pitch P1 that larger than P2, whereby the array of illumination spots is directed at a subset of the discrete signal sources.

2. The system of claim 1 wherein the pitch P1 is about twice the pitch P2.

3. The system of claim 1 wherein about half of the discrete signal sources are illuminated at one time from one diffractive optical element.

4. The system of claim 1 wherein the discrete signal sources are arranged in rows and columns and the pitch for sources within rows is different than the pitch for sources between rows.

5. The system of claim 4 wherein the pitch between rows is larger than the pitch within rows.

6. The system of claim 1 having 2, 3, or 4 diffractive optical elements.

7. The system of claim 1 having at least 5000 discrete signal sources.

8. The system of claim 1 wherein the discrete signal sources are sources associated with chemical, biochemical, or biological materials.

9. The system of claim 8 wherein the materials comprise enzymes, enzyme substrates, antibodies, antigens, ligases, nucleases, or polymerases.

10. The system of claim 1 wherein the signals from the discrete signal sources comprise fluorescent signals.

11. A method comprising:
providing a substrate comprising an array of at least 500 discrete signal sources, the array of discrete signal sources having a pitch P2;
directing excitation light from an excitation source through an optical train to the substrate;
receiving emitted light from the substrate through the optical train at a detector;
wherein the optical train comprises at least one diffractive optical element which divides the light from the excitation source into an array of illumination spots on the substrate, the array of illumination spots having a pitch P1 that larger than P2, whereby the array of illumination spots is directed at a subset of the discrete signal sources.

12. The method of claim 11 wherein the pitch P1 is about twice the pitch P2.

13. The method of claim 11 wherein about half of the discrete signal sources are illuminated at one time from one diffractive optical element.

14. The method of claim 11 wherein the discrete signal sources are arranged in rows and columns and the pitch for sources within rows is different than the pitch for sources between rows.

15. The method of claim 14 wherein the pitch between rows is larger than the pitch within rows.

16. The method of claim 11 having 2, 3, or 4 diffractive optical elements.

17. The method of claim 11 having at least 5000 discrete signal sources.

18. The method of claim 11 wherein the discrete signal sources are sources associated with chemical, biochemical, or biological materials.

19. The method of claim 18 wherein the materials comprise enzymes, enzyme substrates, antibodies, antigens, ligases, nucleases, or polymerases.

20. The method of claim 11 wherein the signals from the discrete signal sources comprise fluorescent signals.
